(19) United States
(12) Patent Application Publication
(10) Pub. No.: US 2010/0312789 A1
(43) Pub. Date: Dec. 9, 2010

(54) ATTRIBUTE DATA PROVIDING APPARATUS AND METHOD

(75) Inventor: Yukio Numakami, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/789,279

(22) Filed: May 27, 2010

(30) Foreign Application Priority Data
Jun. 3, 2009 (JP) 2009-134412

(51) Int. Cl. G06F 17/30

(52) U.S. Cl. 707/769; 707/E17.014

(57) ABSTRACT

An attribute apparatus is connected to a management apparatus that manages a directory for storing contents and a request apparatus that requests attributes of contents, and configured to store an identifier of the directory and identifiers of the contents. The attribute apparatus acquires attribute data of the contents in response to a request, and provides the acquired attribute data and the identifier of the directory stored corresponding to the identifiers of the contents whose attribute data have been acquired, to the request apparatus.

### BACKGROUND OF THE INVENTION

1. Field of the Invention

The present invention relates to an attribute data providing apparatus and an attribute data providing method.

2. Description of the Related Art

In a digital living network alliance (DLNA) that uses a universal plug and play (UPnP), the following method is defined. That is, a method is defined, which stores contents in a digital media server (DMS), and provides contents or metadata accompanying the contents from the DMS to other devices in a home network. As examples of the DMS, a camera apparatus that stores captured contents, and a broadcast content recording/reproducing apparatus that stores broadcast contents can be cited.

On the other hand, Web services such as a photograph sharing site and a video sharing site on Internet have gained in popularity. These are services for storing contents in a content providing apparatus on the Internet and providing the contents or content metadata (content attribute information).

However, the content metadata defined in the UPnP/DLNA and the content metadata used by the content providing apparatus on the Internet are different from each other in format and providing method. Hence, the content metadata used by the content providing apparatus on the Internet cannot be provided to the DLNA device in the home network.

Japanese Patent Application Laid-Open No. 2004-102767 discusses a technology which causes, in place of the content providing apparatus, a metadata providing apparatus to convert content metadata from the content providing apparatus into a format interpretable by the device in the home network and collect the converted data beforehand, and then provide the data to the device in the home network. This metadata providing apparatus collects and converts the content metadata from the content providing apparatus, and then rasterizes the data into a directory structure to store the data therein. When receiving an acquisition request of the content metadata from the device in the home network, the metadata providing apparatus provides the converted content metadata stored therein to the device in the home network.

However, even in the above-mentioned conventional technology, there is a problem in that the metadata providing apparatus cannot provide content metadata not acquirable from the content providing apparatus to the device in the home network.

### SUMMARY OF THE INVENTION

According to an aspect of the present invention, an attribute apparatus connected to a management apparatus that manages a directory for storing contents and a request apparatus that requests attributes of contents includes a storage unit configured to store an identifier of the directory and identifiers of the contents, an acquisition unit configured to acquire attribute data of the contents in response to a request, and a providing unit configured to provide the attribute data and the identifier of the directory corresponding to the identifiers of the contents whose attributes have been acquired, to the request apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a conventional example of a metadata providing system.

FIG. 2 is a block diagram illustrating a hardware configuration example of a metadata providing apparatus.

FIG. 3 is a block diagram illustrating a module configuration example of the metadata providing apparatus.

FIG. 4 illustrates a directory structure in a content providing apparatus.

FIG. 5 illustrates a conversion table.

FIG. 6 is a flowchart illustrating processing when an initial operation is performed.

FIG. 7 is a flowchart illustrating processing when an acquisition request of content metadata is received.

FIG. 8 is a flowchart illustrating processing subsequent to the processing of FIG. 7.

FIG. 9 is a flowchart illustrating processing subsequent to the processing of FIG. 7.

FIG. 10 illustrates an acquisition request message of content list metadata.

FIGS. 11A and 11B illustrate content list metadata.

FIGS. 12A and 12B illustrate content list metadata.

FIGS. 13A and 13B illustrate examples of content information metadata.

### DESCRIPTION OF THE EMBODIMENTS

Various exemplary embodiments, features, and aspects of the invention will be described in detail below with reference to the drawings.

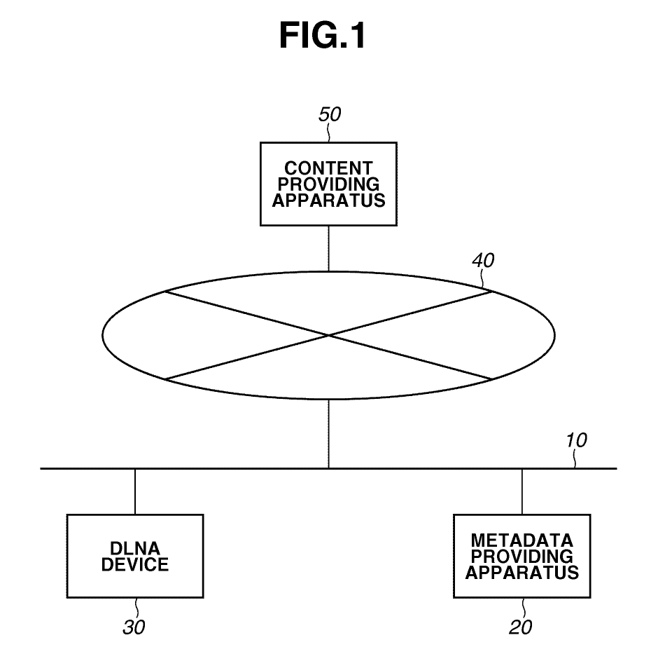

FIG. 1 illustrates a configuration example of a metadata providing system according to the exemplary embodiment.

A LAN 10 is a wired local area network (LAN) or a wireless LAN which is a home network. In the exemplary embodiment, the wired LAN or the wireless LAN is used as the home network. However, the home network is not limited to this LAN. The home network may be, for example, a wide area network (WAN), an ad hoc network, Bluetooth (registered trademark), Zigbee, or UWB.

A metadata providing apparatus 20 acquires, in response to an acquisition request of content metadata from a DLNA device 30 in the LAN 10, content metadata of a content providing apparatus (content management apparatus) 50, and converts the content metadata into a predetermined DIDL-Lite format to provide the data to the DLNA device 30. In the exemplary embodiment, the metadata providing apparatus 20 functions as a DMS in a DLNA. As metadata providing services of the metadata providing apparatus 20, there is a content directory service (CDS) in the DMS. Specific examples of the metadata providing apparatus 20 are a station apparatus, a cradle apparatus, a network relay apparatus, and a PC apparatus. In the exemplary embodiment, as the metadata providing apparatus 20, the apparatus having a function of a DMS in the DLNA is cited. However, any metadata providing apparatus can be employed as long as it has a function of providing content metadata in the home network as in the case of the metadata providing apparatus 20.

The DLNA device 30 is a device in the home network. The DLNA device 30 browses content metadata provided by the metadata providing apparatus 20. Specific examples of the DLNA device 30 are a digital media controller (DMS) and a digital media player (DMP). In the exemplary embodiment, the DLNA device is cited as an example of a reception apparatus. However, any reception apparatus can be employed as long as it has a function of acquiring content metadata in the home network as in the case of the DLNA device 30.

Internet 40 is a WAN functioning as Internet. In the exemplary embodiment, the WAN is used as the Internet. However, in place of the WAN, a LAN, an ad hoc network, a public line, or a next generation network (NGN) may be used.

The content providing apparatus 50 provides contents and content metadata through the Internet 40. In the exemplary embodiment, a format and a providing method of the content metadata provided by the content providing apparatus 50 are different from a format and a providing method of the content metadata provided to the DLNA device 30 by the metadata providing apparatus 20. Specific examples of the content providing apparatus 50 are a PC apparatus and a server apparatus.

FIG. 1 illustrates the configuration of the metadata providing system by taking the example where one metadata providing apparatus 20, one DLNA device 30, and one content providing apparatus 50 are laid. However, at least one of the metadata providing apparatus 20, the DLNA device 30, and the content providing apparatus 50 may be more than one.

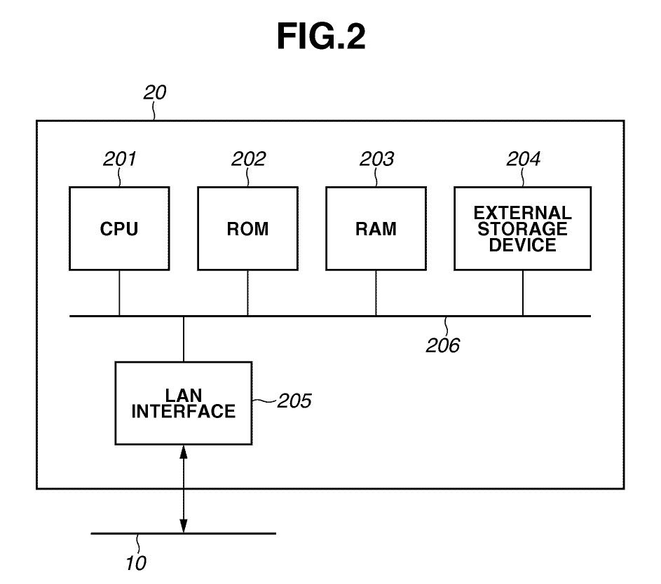

FIG. 2 is a block diagram illustrating a hardware configuration example of the metadata providing apparatus 20. The metadata providing apparatus 20 can be realized also by an apparatus other than a computer system such as a PC. In other words, the metadata providing apparatus 20 can be implemented by various terminals having functions of communicating with other network control apparatus or a combination thereof. Examples of the terminals are a work station, a notebook PC, a palmtop PC, various home electric appliances such as a television incorporating a computer, a game machine having a communication function, and a mobile phone.

In FIG. 2, a central processing unit (CPU) 201 controls the entire metadata providing apparatus 20. A read only memory (ROM) 202 stores a program or a parameter that does not need to be changed. A random access memory (RAM) 203 temporarily stores a program or data supplied from an external apparatus. An external storage device 204 is a hard disk, a memory card fixed to the metadata providing apparatus 20, a flexible disk (FD), or an optical disk such as a compact disk (CD) detachable from the metadata providing apparatus 20. For the external storage device 204, a magnetic card, an optical card, an IC card, or a memory card may be used. A LAN interface 205 performs communication control for connection to the LAN 10. A system bus 206 interconnects the units 201 to 205 for communication with one another.

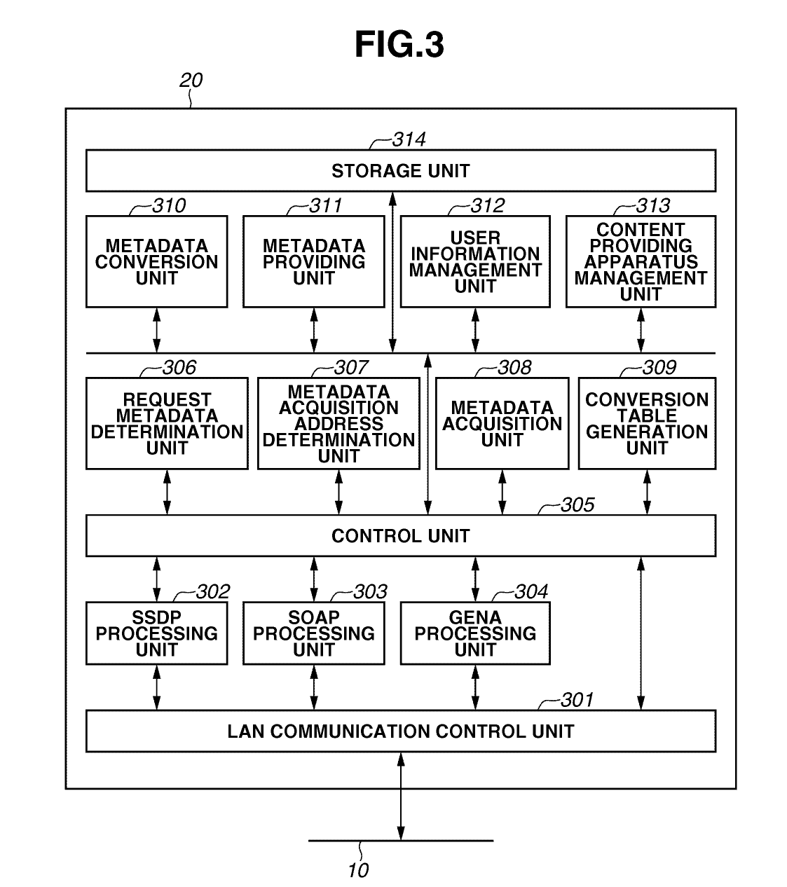

FIG. 3 is a block diagram illustrating a software module configuration example of the metadata providing apparatus 20.

A LAN communication control module 301 performs communication control for connection to the LAN 10 via the LAN interface 105.

A SSDP processing module 302 receives a corresponding packet from the LAN communication control module 301, and performs simple service discovery protocol (SSDP) processing of UPnP. In the SSDP processing, presence of the metadata providing apparatus 20 as a DMS in the LAN 10 is advertised to other DLNA devices including the DLNA device 30. This advertisement is performed based on an alive message in the SSDP. In the SSDP processing, other UPnP services in the LAN 10 are discovered or a response is made concerning discovery of UPnP services from the other DLNA devices. In the exemplary embodiment, the SSDP processing is used. However, in place of the SSDP processing, other processing using WS-Discovery or media access control (MAC) may be performed.

A SOAP processing module 303 receives a corresponding packet from the LAN communication control module 301, and performs simple access object protocol (SOAP) processing of UPnP. In the SOAP processing, a request is made for other UPnP services, UPnP service requests are received from the other DLNA devices, and a response is made to the requests. Especially, the SOAP processing module 303 receives an acquisition request of content metadata as an example of content attribute information from the DLNA device 30 in the LAN 10. The SOAP processing module 303 transmits a response to the acquisition request of the content metadata to the DLNA device 30. In the exemplary embodiment, the SOAP processing is used. However, in place of the SOAP processing, other processing for executing a remote object such as a remote procedure call may be performed.

A GENA processing module 304 receives a corresponding packet from the LAN communication control module 301, and performs general event notification architecture (GENA) of UPnP. In the GENA processing, the other DLNA devices in the LAN 10 are notified of events, or events of UPnP services of the other DLNA devices are purchased. In the exemplary embodiment, the GENA processing is used. However, in place of the GENA processing, other processing using WS-Eventing or WS-Notification may be performed.

A control module 305 controls the entire metadata providing apparatus 20. The control module 305 manages and controls the modules 301 to 314.

A request metadata determination module 306 determines a content identifier of a request target and a requested metadata type with respect to the “acquisition request of the content metadata from the DLNA device 30 in the LAN 10” received by the SOAP processing unit 303. In the exemplary embodiment, as a requested metadata type to be determined, a BrowseFlag parameter indicating a metadata type in a Browse action of the CDS is used.

More specifically, the BrowseFlag parameter includes two types: BrowseMetadata and BrowseDirectChildren. The BrowseMetadata indicates an acquisition request of content metadata regarding a target content itself. The BrowseDirectChildren indicates, when a class of a target content is Container in DIDL-Lite, an acquisition request of a list of contents contained in the Container. The Container is a directory. The BrowseDirectChildren means an acquisition request of content metadata of a list of contents (content list) in the directory.

As described above, there are two types of content meta data. Hereinafter, in the exemplary embodiment, content metadata regarding a content itself is referred to as content information metadata. Content metadata regarding a content list is referred to as content list metadata.

A metadata acquisition address determination module 307 determines, based on a determination result of a requested metadata type of the requested metadata determination module 306, an address of content metadata acquired from the content providing apparatus 50. An address of content metadata in the exemplary embodiment is a uniform resource identifier (URI). More specifically, if the determination result of the requested metadata type of the requested metadata determination module 306 is BrowseMetadata, the metadata acquisition address determination module 307 determines a content information metadata acquisition address as an address of content metadata. On the other hand, if the determination result of the requested metadata type of the requested metadata determination module 306 is BrowseDirectChildren, the metadata acquisition address determination module 307 determines a content list metadata acquisition address as an address of content metadata.

A metadata acquisition module 308 acquires, based on the address determined by the metadata acquisition address determination module 307, content metadata from the content providing apparatus 50.

A conversion table generation module 309 extracts, from the content metadata acquired by the metadata acquisition module 308, information necessary when data is converted into DIDL-Lite to generate a conversion record. The conversion table generation module 309 stores the generated conversion record in a conversion table prepared in the external storage device 204 of the metadata providing apparatus 20 illustrated in FIG. 2 via the storage module 314. Contents of the conversion table will be described below.

A metadata conversion module 310 converts the content metadata acquired by the metadata acquisition module 308 into content metadata of a predetermined DIDL-Lite format by using the conversion table generated by the conversion table generation module 309. A metadata providing module 311 returns the content metadata converted by the metadata conversion module 310 as a response to the Browse action of the CDS to the DLNA device 30 in the LAN 10 via the SOAP processing module 303.

A user information management module 312 manages a user information table stored in the external storage device 204 of the metadata providing apparatus 20 illustrated in FIG. 2 via the storage module 314. The user information table includes user account information when the content providing apparatus 50 is used. A content providing apparatus management module 313 logs into the content providing apparatus 50.

The storage module 314 stores target information in a storage area of the external storage device 204 of the metadata providing apparatus 20 illustrated in FIG. 2. The storage module 314 stores, for example, the conversion table generated by the conversion table generation unit 309 or the user information table generated by the user information management module 312 in the storage area of the external storage device 204.

An example of the user information table managed by the user information management module 312 of the metadata providing apparatus 20 illustrated in FIG. 3 will be described. In the exemplary embodiment, the user information table includes, as records, a user ID, a password, and a root content information metadata acquisition address.

Each of the user ID and the password is authentication information of each user necessary for using the content providing apparatus 50. In the exemplary embodiment, the example where “user ID and password” stored in the user information table are used for user authentication has been descried. However, user authentication may also be performed by using another method such as an authentication token.

The root content information metadata acquisition address is used for acquiring content information metadata in the root directory for a current user of the content providing apparatus 50. The address varies from one user to another of the content providing apparatus 50. Normally, when a user opens an account in the content providing apparatus 50, the content providing apparatus 50 determines a root content information metadata acquisition address. This root content information metadata acquisition address is accordingly a statically unique address. In the exemplary embodiment, the root content information metadata acquisition address is determined, based on a method defined by the content providing apparatus 50, beforehand from a combination of a base address and a user ID.

In the exemplary embodiment, the root content information metadata acquisition address stored in the user information table managed by the user information management module 312 is used. However, the use of this address is in no way limitative. For example, another method may be used, which dynamically determines a root content information metadata acquisition address from the combination of the base address and the user ID defined by the content providing apparatus 50 without holding any root content information metadata acquisition address in the user information table.

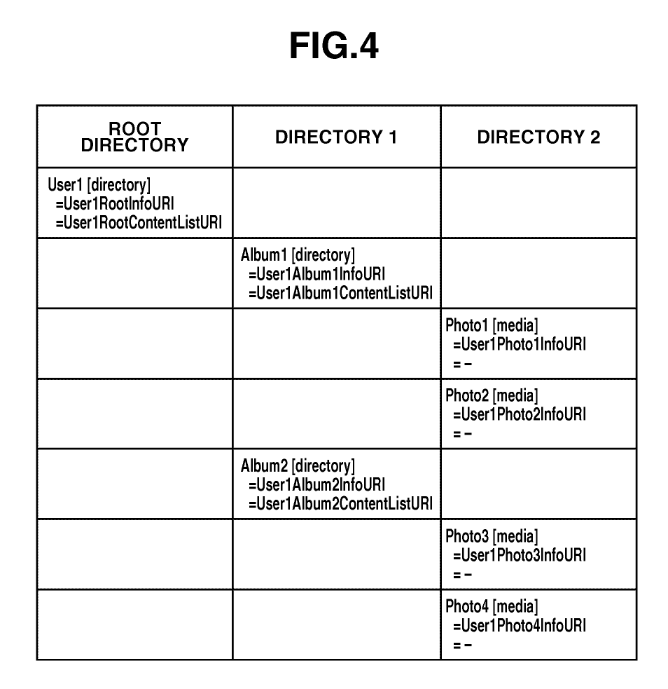

FIG. 4 illustrates an example of a directory structure in the content providing apparatus 50. More specifically, FIG. 4 illustrates an example of a directory structure of a user ID “User1” in the user information table. In the directory structure of the content providing apparatus 50, there are other user directory structures in addition to the user ID “User1”.

The “User1” in the root directory of FIG. 4 is a root directory for “User1” in the content providing apparatus 50. “[directory]” indicates that a content is a directory. The content includes a directory and a medium. The directory is a kind of content. An upper “User1RootInfoURI” is a content information metadata acquisition address for the root directory “User1”. The content information metadata acquisition address for the root directory “User1” is a root content information metadata acquisition address of the user information table managed by the user information management module 312. A lower “User1RootContentListURI” is a content list metadata acquisition address for the root directory “User1”.

“Album1” in a directory 1 of a first tier of FIG. 4 is a directory (subdirectory) included in the root directory “User1”. An upper “User1Album1InfoURI” is a content information metadata acquisition address for the directory “Album1”. A lower “User1Album1ContentListURI” is a content list metadata acquisition address for the directory “Album1”.

“Photo1” in a directory 2 of a second tier of FIG. 4 is a medium included in the directory “Album1”. “[media]” indicates that a content is a medium. An upper “User1Photo1InfoURI” is a content information metadata acquisition address of the medium “Photo1”. The medium “Photo1” is not a directory, and hence there is no content list metadata acquisition address. In FIG. 4, “-” indicates that there is no content list metadata acquisition address. Other sections of FIG. 4 show contents similar to the above, and thus detailed description thereof will be omitted.

In the exemplary embodiment, the case of the two-tier directory structure has been taken as an example. However, the directory structure is not limited to the two tiers. A directory structure including three or more tiers may be employed, or a directory content and a media content may be mixed in one and the same directory (e.g., directory of a first tier).

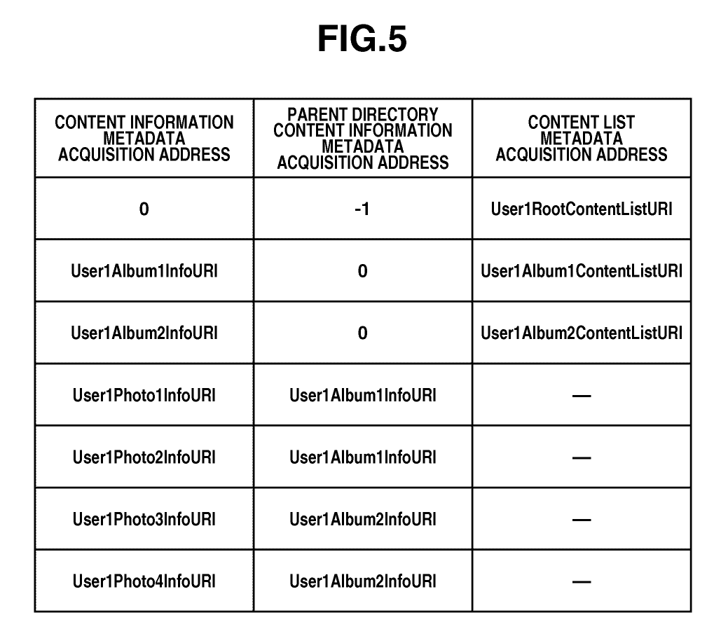

FIG. 5 illustrates an example of a conversion table generated by the conversion table generation module 309 of the metadata providing apparatus 20 illustrated in FIG. 3. More specifically, FIG. 5 illustrates an example of a conversion table for the directory structure in the content providing apparatus 50 illustrated in FIG. 4. In the exemplary embodiment, the conversion table includes, as records, a content information metadata acquisition address, a parent directory content information metadata acquisition address, and a content list metadata acquisition address.

The content information metadata acquisition address of FIG. 5 is for acquiring content information metadata (content metadata regarding content itself) from the content providing apparatus 50. The content information metadata acquisition address is used, after content metadata provided from the content providing apparatus 50 is converted into DIDL-Lite, as a content identifier (ID) for each content of the DIDL-Lite.

In DLNA specifications, a content identifier in a root container (root directory) of the DIDL-Lite is fixed to “0”. Thus, in the exemplary embodiment, in the first record of the conversion table of FIG. 5, a content information metadata acquisition address for the root directory “User1” is set to “0”. For the content information metadata acquisition address in the root directory “User1”, a root content information metadata acquisition address in the user ID “User1” of the user information table is used.

The parent directory content information metadata acquisition address is a content information metadata acquisition address regarding a parent directory (upper tier directory) of a content indicated by the content information metadata acquisition address (content identifier) in one and the same record. The parent directory content information metadata acquisition address is used, after content metadata provided from the content providing apparatus 50 is converted into DIDL-Lite, as a parent directory content identifier (ParentID) for each content of the DIDL-Lite. The parent directory content information metadata acquisition address of the content is an identifier indicating a storage area in which the content has been stored.

The parent directory content information metadata acquisition address of the directory “Album1” (“User1Album1InfoURI”) is a content information metadata acquisition address “0” of the root directory that is a parent directory.

In DLNA specifications, a parent content identifier in the root container (root directory “User1”) of the DIDL-Lite is fixed to “−1”. Thus, in the exemplary embodiment, in the first record of the conversion table of FIG. 5, a parent directory content information metadata acquisition address corresponding to the root directory “User1” is “−1”.

The content list metadata acquisition address is used for acquiring content list metadata regarding a list of contents belonging to a directory content indicated by the content information metadata acquisition address included in the same record as that of the content list metadata acquisition address. In other words, the content list metadata acquisition address is valid only when a content indicated by the content information metadata acquisition address in the same record is a container (directory). Thus, in the fourth record of the conversion table of FIG. 5, there is no content list metadata acquisition address for the medium “Photo1”. As in the case of the fourth record of the conversion table, there is no content list metadata acquisition address in the fifth record and after of the conversion table.

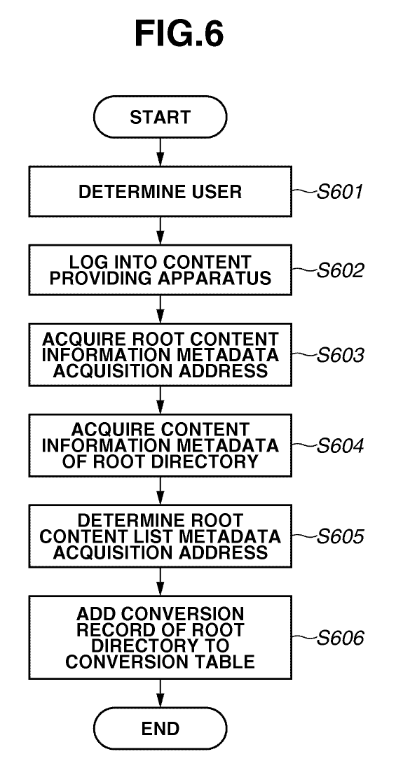

FIG. 6 is a flowchart illustrating an example of processing of the metadata providing apparatus 20 when an initial operation necessary for providing content metadata of the content providing apparatus 50 to the DLNA device 30 in the LAN 10 is performed. This flowchart illustrates a part of a program executed by the CPU 201 that is a computer. The CPU 201 reads this program from the ROM 202 or the external storage device 204 into the RAM 203, and executes the program. The ROM 202 or the external storage device 204 is a storage medium for storing the program so as to enable the CPU 201 to read the program.

In step S601, the user information management module 312 determines a user of the content providing apparatus 50. This user is determined from a user ID of the user information table stored in the external storage device 204. The determination of the user is made, for example, based on user ID setting performed by the user for the metadata providing apparatus 20.

In step S602, the content providing apparatus management module 313 logs into the content providing apparatus 50 based on information of the user determined in step S601. In this case, the content providing apparatus management module 313 requests authentication processing to the content providing apparatus 50 by using “a user ID and a password” corresponding to the user in the user information table.

In step S603, the content providing apparatus management module 313 acquires a root content information metadata acquisition address corresponding to the user in the user information table. In step S604, the metadata acquisition module 308 acquires content information metadata of the root directory from the content providing apparatus 50 by using the root content information metadata acquisition address acquired in step S603. The acquired content information metadata is metadata regarding the root directory itself.

In step S605, the conversion table generation module 309 determines a content list metadata acquisition address of the root directory. To determine a content list metadata acquisition address, the following two methods are available. In the first method, a content list metadata acquisition address has directly been written in the content information metadata acquired in step S604. In the second method, based on a method defined by the content providing apparatus 50, a content list metadata acquisition address can be uniquely determined from a combination of a base address regarding the content list metadata acquisition address and information regarding a root content. The information regarding the root content is, for example, a content identifier, and described in the content information metadata acquired in step S604. These determination methods vary from one content providing apparatus 50 to another. In the exemplary embodiment, hereinafter, processing is based on the former method. Needless to say, the processing can be executed based on the latter method.

In step S606, the conversion table generation module 309 generates a conversion record for the root directory by using the content list metadata acquisition address determined in step S605. Then, the conversion table generation module 309 stores the generated conversion record in the conversion table prepared in the external storage device 204 of the metadata providing apparatus 20 illustrated in FIG. 2 via the storage module 314.

The “conversion record for the root directory” generated in step S606 is, more specifically, a first record in the conversion table of FIG. 5. As described above, the content information metadata acquisition address in the root directory is “0”, and the parent directory content information metadata acquisition address is “−1”. The content list metadata acquisition address is determined in step S605, and it is “User1RootCOntentListURI” in this example.

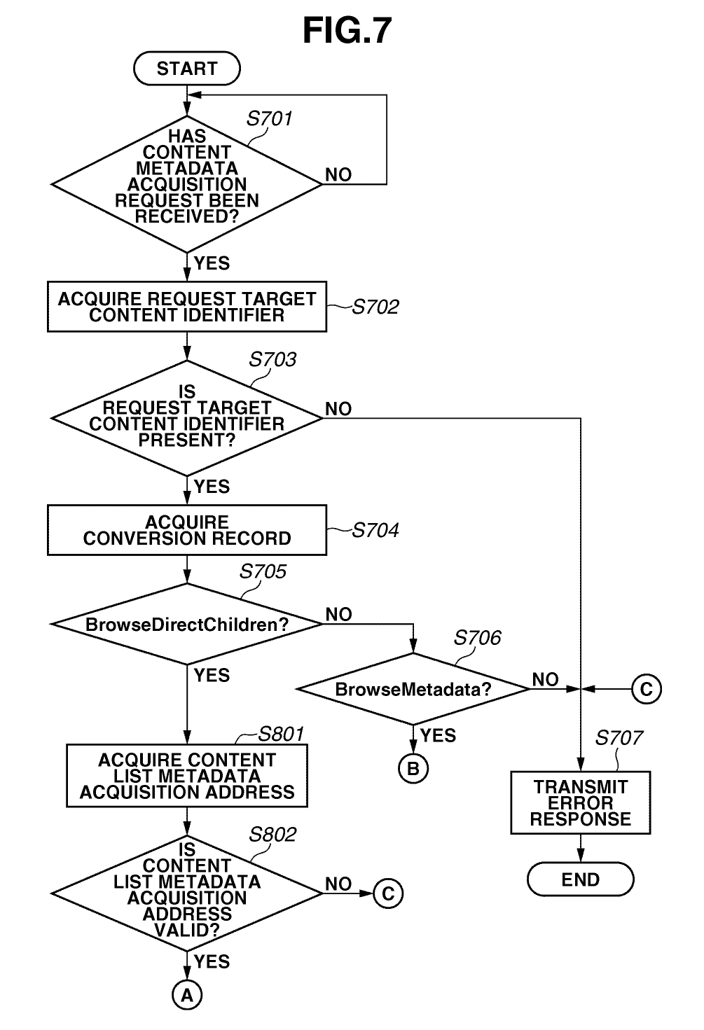

FIGS. 7 to 9 are flowcharts each illustrating an example of a metadata providing operation in the metadata providing apparatus 20 when an acquisition request of content metadata is received from the DLNA device 30 in the LAN 10. The flowcharts illustrate parts of the program executed by the CPU 201 that is a computer. The CPU 201 reads the program from the ROM 202 or the external storage device 204 into the RAM 203, and executes the program. The ROM 202 or the external storage device 204 is a storage medium for storing the program so as to enable the CPU 201 to read the program.

In step S701, the control module 305 determines whether an acquisition request of content metadata has been received from the DLNA 30 in the LAN 10. More specifically, the control module 305 determines whether the SOAP processing module 303 has received a Browse action of the CDS. If a result of the determination shows that no acquisition request of content data has been received (NO in step S701), the control module 305 repeats step S701. On the other hand, if an acquisition request of content data has been received (YES in step S701), the processing proceeds to step S702.

In step S702, the requested metadata determination module 306 acquires an identifier of a content of a request target (request target content identifier) from the acquisition request of content metadata received in step S701. More specifically, the requested metadata determination module 306 acquires ObjectID that is a first parameter of the Browse action of the CDS acquired by the SOAP processing module 303 in step S701.

In step S703, the requested metadata determination module 306 determines whether the request target content identifier acquired in step S702 is present in the conversation table. More specifically, the requested metadata determination module 306 determines whether the ObjectID acquired in step S702 is present in a field of the content information metadata acquisition address of the conversion table illustrated in FIG. 5. If a result of the determination shows that the ObjectID acquired in step S702 is present in the field of the content information metadata acquisition address of the conversion table (YES in step S703), the processing proceeds to step S704. On the other hand, if the ObjectID acquired in step S702 is not present in the field of the content information metadata acquisition address of the conversion table (NO in step S703), the processing proceeds to step S707 described below.

Normally, in a state immediately after the flowchart of the initial operation illustrated in FIG. 6, only a conversion record for the root directory is present in the conversion table. In other words, only the first record of the conversion table illustrated in FIG. 5 is present in the conversion table. When the DLNA device 30 in the LAN 10 makes a first acquisition request of content metadata to the metadata providing apparatus 20, normally, the DLNA device 30 makes an acquisition request of content metadata for the root directory. Thus, the determination result of step S703 is normally “present”.

In step S704, the requested metadata determination module 306 acquires a record (conversion record) including the request target content identifier acquired in step S702 from the conversion table.

In step S705, the requested metadata determination module 306 determines whether a requested metadata type included in the acquisition request of the content metadata received in step S701 is BrowseDirectChildren. More specifically, the requested metadata determination module 306 determines whether a second parameter of the Browse action of the CDS acquired by the SOAP processing module 303 in step S701 is BrowseDirectChildren. If a result of the determination shows that the requested metadata type is BrowseDirectChildren (YES in step S705), the processing proceeds to step S801. On the other hand, if the requested metadata type is different from BrowseDirectChildren (NO in step S705), the processing proceeds to step S706.

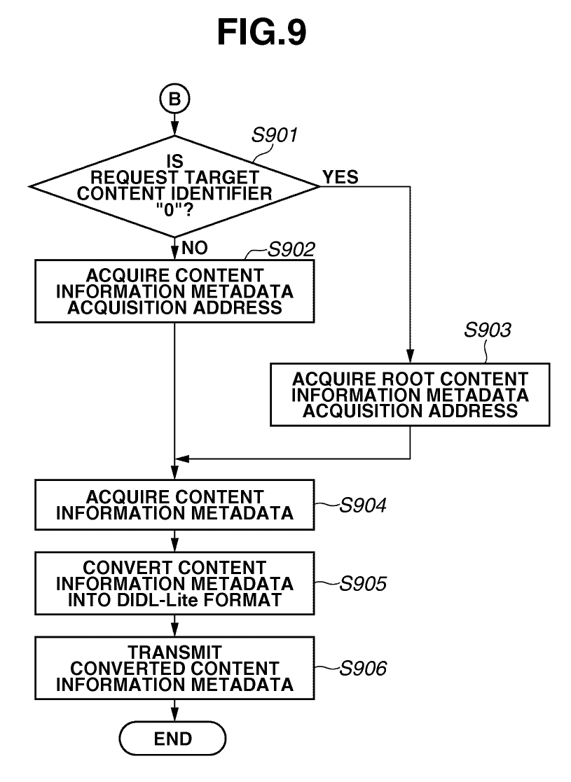

In step S706, the requested metadata determination module 306 determines whether the requested metadata type included in the acquisition request of content metadata received in step S701 is BrowseMetadata. More specifically, the requested metadata determination module 306 determines whether the second parameter of the Browse action of the CDS acquired by the SOAP processing module 303 in step S701 is BrowseMetadata. If a result of the determination shows that the requested metadata type is BrowseMetadata (YES in step S706), the processing proceeds to step S901 of FIG. 9 described below. On the other hand, if the requested metadata type is different from BrowseMetadata (NO in step S706), the processing proceeds to step S707.

In step S707, the metadata providing module 311 transmits an error response indicating that a request parameter is unauthorized, to the DLNA device 30 in the LAN 10. More specifically, the metadata providing module 311 returns an error response indicating that the request parameter is unauthorized as a response to the Browse action of the CDS to the DLNA device 30 in the LAN 10 via the SOAP processing module 303. Then, the control module 305 terminates the metadata providing operation. In order to repeat the metadata providing operation, the control module 305 may return the processing to the start (step S701) of FIG. 7.

In step S801, the metadata acquisition address determination module 307 acquires a content list metadata acquisition address of the content supplied in step S701 from the conversion record acquired by the requested metadata determination module 306 in step S704.

In step S802, the metadata acquisition address determination module 307 determines whether the content list metadata acquisition address acquired in step S801 is valid. If a result of the determination shows that the content list metadata acquisition address is valid (YES in step S802), the processing proceeds to step S803. On the other hand, if the content list metadata acquisition address is not valid (NO in step S802), the processing proceeds to step S707. A typical example where the content list metadata acquisition address is invalid in this case is when a request target content is not a directory (container) but a medium (item).

In step S803, the metadata acquisition module 308 acquires content list metadata from the content providing apparatus 50 by using the content list metadata acquisition address acquired in step S801. The content list metadata acquired in this case is metadata regarding a list of contents belonging to the directory content requested in step S701.

In step S804, the conversion table generation module 309 extracts metadata regarding each content belonging to the directory content from the content list metadata acquired in step S803. Thereafter, processing of steps S805 to S809 is executed as to metadata of one target content.

In step S805, the conversion table generation module 309 determines a content information metadata acquisition address based on the metadata of the content extracted in step S804. There are two determination methods as in the case of the determination method of the content list metadata acquisition address described above in step S605 of FIG. 6.

In the first method, a content information metadata acquisition address has directly been described in the metadata of the content extracted in step S804. In the second method, based on a method defined by the content providing apparatus 50, a content information metadata acquisition address can be uniquely determined from a combination of a base address regarding the content information metadata acquisition address and information regarding a relevant (acquisition-requested) content. The information regarding the relevant content is, for example, a content identifier, and described in the metadata of the content extracted in step S804. These determination methods vary from one content providing apparatus 50 to another. In the exemplary embodiment, as in the case of step S605, the former is assumed.

In step S806, the conversion table generation module 309 determines whether the content information metadata acquisition address determined in step S805 is present in the conversion table. More specifically, the conversion table generation module 309 determines whether the content information metadata acquisition address determined in step S805 is present in the field of the content information metadata acquisition address of the conversion table illustrated in FIG. 5. If a result of the determination shows that the content information metadata acquisition address is present in the field of the content information metadata acquisition address of the conversion table (YES in step S806), the conversion table generation module 309 determines that the content has been registered in the conversion table. The processing skips steps S807 to 5809 to proceed to step S810. On the other hand, if the content information metadata acquisition address is not present in the field of the content information metadata acquisition address of the conversion table (NO in step S806), the conversion table generation module 309 determines that the content is yet to be registered in the conversion table, and proceeds to step S807.

In step S807, the conversion table generation module 309 determines whether the content is a directory. More specifically, the conversion table generation module 309 determines whether the content is a directory based on attribute information of the metadata of the content extracted in step S804. If a result of the determination shows that the content is a directory (YES in step S807), the processing proceeds to step S808. On the other hand, if the content is not a directory, the processing skips step S808 to proceed to step S809.

In step S808, the conversion table generation module 309 determines a content list metadata acquisition address of the content determined to be a directory. A determination method of the content list metadata acquisition address is similar to that described above in step S605 of FIG. 6, and thus detailed description thereof will be omitted.

In step S809, the conversion generation table 309 generates a conversion record of the content by using the content information metadata acquisition address determined in step S805. The content information metadata acquisition address is used for acquiring metadata of the content belonging to the directory content requested in step S701.

When proceeding from step S808 to step S809, the conversion table generation module 309 generates a conversion record for the content by using the content list metadata acquisition address determined in step S808. This content information metadata acquisition address is used for acquiring content list metadata belonging to a child directory when the content belonging to the directory content requested in step S701 is a directory content (child directory of requested directory). The parent directory content information metadata acquisition address is the request target content identifier (ObjectID) acquired in step S702 of FIG. 7.

The conversion table generation module 309 adds the generated conversion record to the conversion table prepared in the external storage device 204 of the metadata providing apparatus 20 illustrated in FIG. 2 via the storage module 314.

In step S810, the conversion table generation module 309 determines whether the metadata regarding the contents extracted in step S804 are all targeted for processing. If a result of the determination shows that not all the metadata regarding the contents are targeted for processing (NO in step S810), the processing returns to step S804. On the other hand, if all the metadata regarding the contents are targeted for processing, the processing proceeds to step S811.

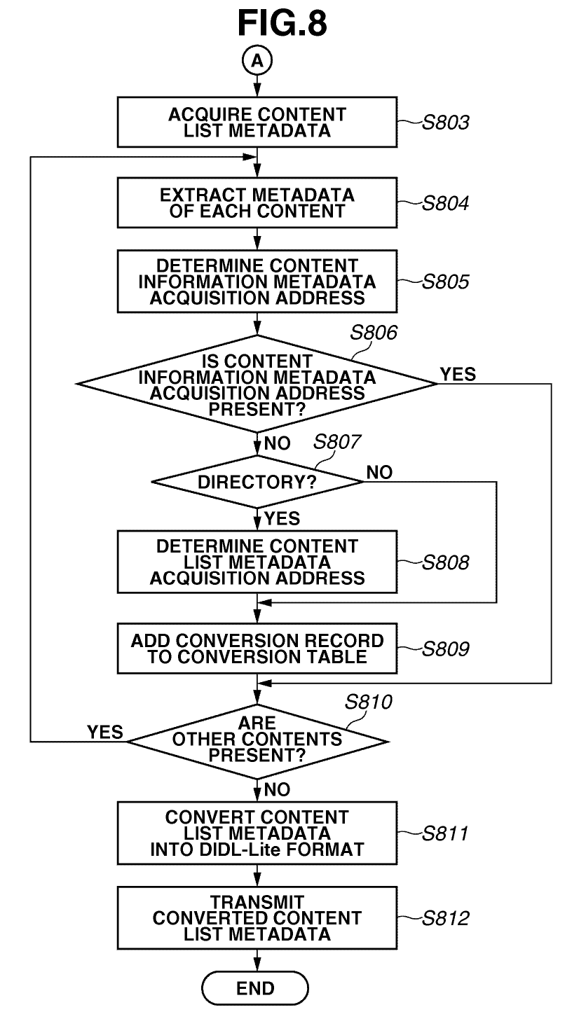

In step S811, the metadata conversion module 310 converts the content list metadata acquired in step S803 of FIG. 8 into metadata of a predetermined DIDL-Lite format. For the conversion, for each content included in the content list, as a content identifier (ID), the content information metadata acquisition address determined in step S805 of FIG. 8 is used. As a parent directory content identifier (ParentID), the request target content identifier (ObjectID) acquired in step S702 of FIG. 7 is used.

In step S812, the metadata providing module 311 transmits the content list metadata converted in step S811 to the DLNA device 30 in the LAN 10. More specifically, the metadata providing module 311 returns the content list metadata converted in step S811 as a response to the Browse action of the CDS to the DLNA device 30 in the LAN 10 via the SOAP processing module 303.

Then, the control module 305 terminates the metadata providing operation illustrated in FIG. 7. In order to repeat the metadata providing operation, the control module 305 may return the processing to the start of FIG. 7.

FIG. 9 is a flowchart illustrating processing performed when in step S706 of FIG. 7, the requested metadata determination module 306 determines that the requested metadata type is BrowseMetadata.

In step S901, the requested metadata determination module 306 determines whether the request target content identifier acquired in step S702 of FIG. 7 is “0”, in other words, whether the request target content is a root directory. If a result of the determination shows that the request target content identifier is not “0” (NO in step S901), the processing proceeds to step S902. On the other hand, if the request target content identifier is “0” (YES in step S901), the processing proceeds to step S903. When the request target content identifier is “0”, the request target content is a root directory of the DIDL-Lite.

In step S902, the metadata acquisition address determination module 307 acquires a content information metadata acquisition address from the conversion record acquired by the requested metadata acquisition module 306 in step S704 of FIG. 7. Then, the processing proceeds to step S904. In step S903, the metadata acquisition address determination module 307 acquires a root content information metadata acquisition address from the user information table of the user. Then, the processing proceeds to step S904.

In step S904, the metadata acquisition module 308 acquires content information metadata from the content providing apparatus 50 by using the content information metadata acquisition addresses acquired in steps S902 and S903.

In step S905, the metadata conversion module 310 converts the content information metadata acquired in step S904 into metadata of a predetermined DIDL-Lite format. For the conversion, as content identifiers (ID), the content information metadata acquisition addresses acquired in steps S902 and S903 are used. For a parent directory content identifier (ParentID), the parent directory content information metadata acquisition address in the conversion record acquired by the requested metadata determination module 306 in step S704 of FIG. 7 is used.

In step S906, the metadata providing module 311 transmits the content information metadata converted in step S905 to the DLNA device 30 in the LAN 10. More specifically, the metadata providing module 311 returns the content information metadata converted in step S905 as a response to the Browse action of the CDS to the DLNA device 30 in the LAN 10 via the SOAP processing module 303. Then, the control module 305 terminates the metadata providing operation illustrated in FIG. 7. In order to repeat the metadata providing operation, the control module 305 may return the processing to the start of FIG. 7.

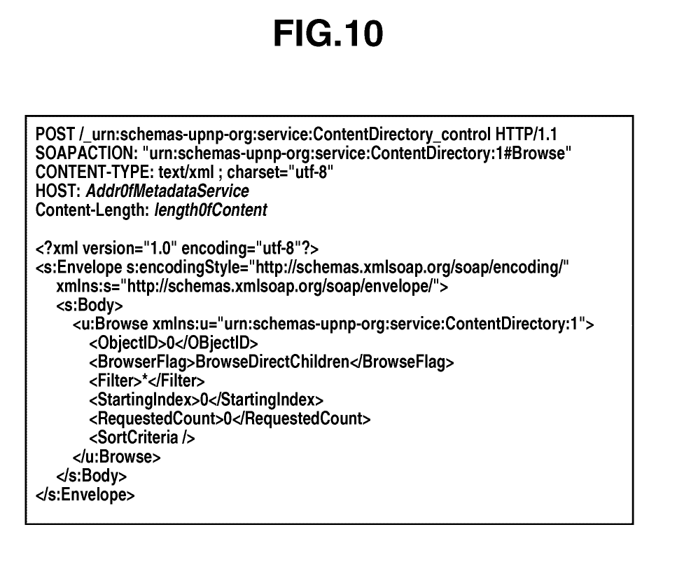

FIG. 10 illustrates an example of an acquisition request message of content list metadata for the root directory to be transmitted to the metadata providing apparatus 20. This is a SOAP request message of the Browse action of the CDS. A request target content identifier that is a first parameter of the Browse action of the CDS is “0” indicating a root directory. A requested metadata type that is a second parameter is “BrowseDirectChildren” indicating content list metadata.

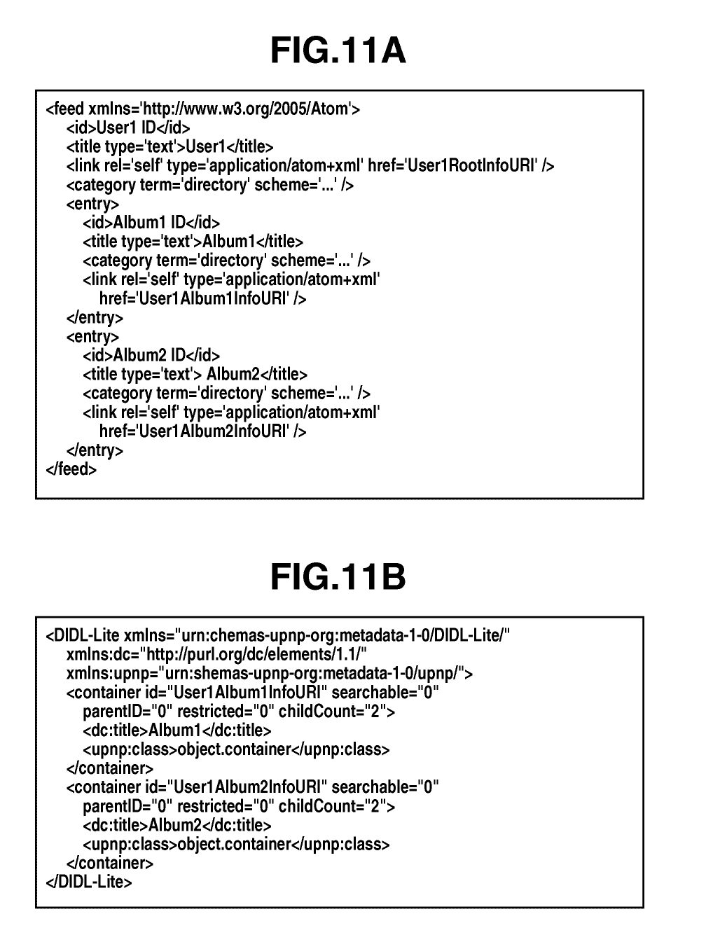

FIG. 11A illustrates an example of content list metadata acquired from the content providing apparatus 50 by the metadata providing apparatus 20 in response to the acquisition request of content list metadata to the root directory illustrated in FIG. 10. In this example, a metadata format of the content providing apparatus 50 is The Atom Publishing Protocol. In the exemplary embodiment, the metadata format of the content providing apparatus 50 is The Atom Publishing Protocol is cited as an example. However, the metadata format of the content providing apparatus 50 is not limited to this format. For example, a representational state transfer (REST) format metadata or own format metadata may be used.

In this example, the root directory “User1” includes two directories “Album1” and “Album2”. That the content is a directory can be determined based on attribute information of a category element. Content information metadata acquisition addresses of the directories “Album1” and “Album2” are “User1Album1InfoURI” and “User1Album2InfoURI”. When the root directory includes media contents, metadata of the media contents are acquired.

FIG. 11B illustrates an example of a result of converting the content list metadata acquired from the content providing apparatus 50 illustrated in FIG. 11A into metadata of a predetermined DIDL-Lite format by using the conversion table of FIG. 5. In this example, a content identifier (ID) of the directory “Album1” is “User1Album1InfoURI”, and a parent directory content identifier (ParentID) is “0”. This parent directory content identifier (ParentID) “0” is a request target content identifier of FIG. 10. Similarly, a content identifier (ID) of the directory “Album2” is “User1Album2InfoURI”, and a parent directory content identifier (ParentID) is “0”.

A content list metadata acquisition request message for the directory “Album1” transmitted to the metadata providing apparatus 20 from the DLNA device 30 in the LAN 10 is a SOAP request message of a Browse action of the CDS. In this acquisition request message, a request target content identifier that is a first parameter of the Browse action of the CDS is “User1Album1InfoURI” indicating the directory “Album1”.

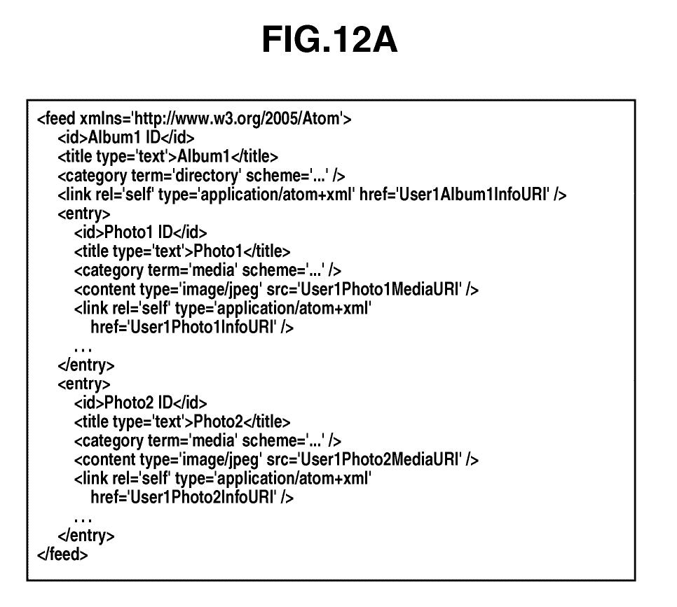

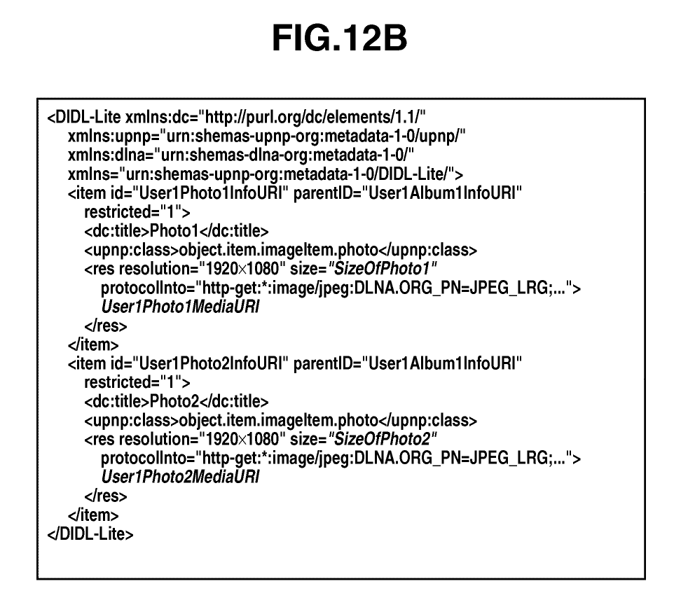

FIG. 12A illustrates an example of content list metadata acquired from the content providing apparatus 50 by the metadata providing apparatus 20 in response to the acquisition request of content list metadata to the directory “Album1”. In this example, as in the case of FIG. 11A, a metadata format of the content providing apparatus 50 is the Atom Publishing Protocol. In this example, the directory “Album1” includes two media “Photo1” and “Photo2”. That the content is a medium can be determined based on attribute information of a category element or attribute information of a content element. Content information metadata acquisition addresses of the media “Photo1” and “Photo2” are “User1Photo1InfoURI” and “User1OPhoto2InfoURI”.

FIG. 12B illustrates an example of a result of converting the content list metadata acquired from the content providing apparatus 50 illustrated in FIG. 12A into metadata of a predetermined DIDL-Lite format by using the conversion table of FIG. 5. In this example, a content identifier (ID) of the medium “Photo1” is “User1Photo1InfoURI”, and a parent directory content identifier (ParentID) is “User1Album1InfoURI”. This parent directory content identifier (ParentID) is a request target content identifier added to the acquisition request message of the content list metadata for the “Album1” transmitted to the metadata providing apparatus 20. Similarly, a content identifier (ID) of the medium “Photo2” is “User1Photo2InfoURl”, and a parent directory content identifier (ParentID) is “User1Album1InfoURI”.

A content information metadata acquisition request message for the medium “Photo1” transmitted to the metadata providing apparatus 20 from the DLNA device 30 in the LAN 10 is a SOAP request message of a Browse action of the CDS, which is similar to that of FIG. 10. In this acquisition request message, a request target content identifier that is a first parameter of the Browse action of the CDS is “User1Photo1InfoURI” indicating the medium “Photo1”. A requested metadata type that is a second parameter is “BrowseMetadata” indicating content information metadata.

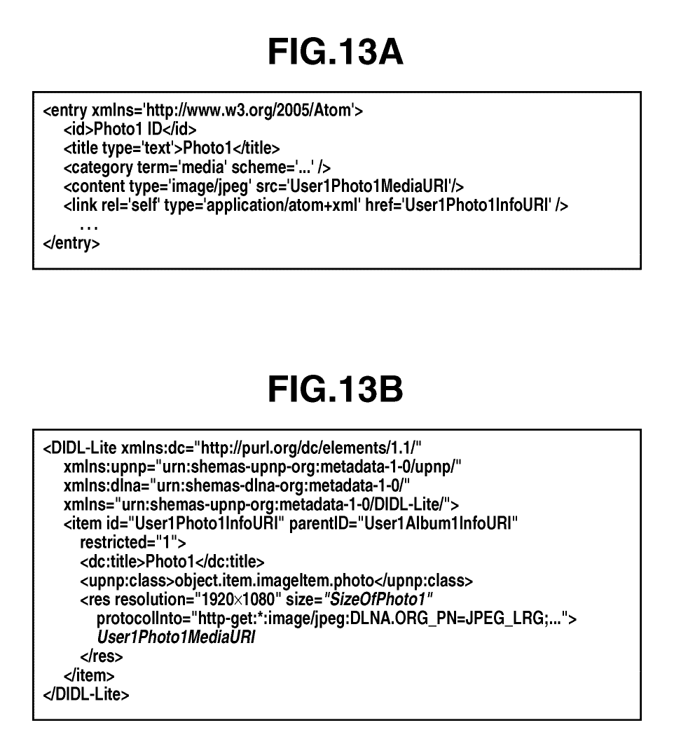

FIG. 13A illustrates an example of content information metadata acquired from the content providing apparatus 50 by the metadata providing apparatus 20 in response to the acquisition request of content information metadata to the medium “Photo1”. In this example, as in the case of FIGS. 11A and 12A, a metadata format of the content providing apparatus 50 is the Atom Publishing Protocol. The acquired metadata is a data format (compressed format in the case of compressed image data). A content information metadata acquisition address of the medium “Photo1” is “User1Album1InfoURI”. In this case, the content information metadata of the medium “Photo1” contains no information regarding the parent directory “Album1”.

FIG. 13B illustrates an example of a result of converting the content information metadata acquired from the content providing apparatus 50 illustrated in FIG. 13A into metadata of a predetermined DIDL-Lite format by using the conversion table of FIG. 5. In this example, a content identifier (ID) of the medium “Photo1” is “User1Photo1InfoURI”, and a parent directory content identifier (ParentID) is “User1Album1InfoURI”.

As described above, in the exemplary embodiment, upon reception of an acquisition request of content list metadata from the DLNA device 30, the metadata providing apparatus 20 adds a record of the conversion table for a relevant content. The record of the conversion table includes a content information metadata acquisition address, a parent directory content information metadata acquisition address, and a content list metadata acquisition address.

Upon reception of an acquisition request of content metadata from the DLNA device 30, the metadata providing apparatus 20 acquires content metadata from the content providing apparatus 50 by using the content list metadata acquisition address stored in the conversion table. The metadata providing apparatus 20 converts the acquired content metadata into a predetermined format that can be processed by the DLNA device 30. In this case, a relevant content information metadata acquisition address is used as a content identifier, and a relevant parent directory content information metadata acquisition address is used as a parent directory content identifier. The metadata providing apparatus 20 transmits the converted content metadata to the DLNA device 30.

The metadata providing apparatus 20 can dynamically convert the content metadata of the content providing apparatus 50 by adding correct directory information and provide the metadata to the DLNA device 30 in the LAN 10. Thus, even when a content of the content providing apparatus 50 is updated in real time, the metadata providing apparatus 20 can immediately provide metadata reflecting the updated content to the DLNA device 30 in the LAN 10. As a result, user-friendliness is improved.

When an acquisition request of content list metadata is received from the DLNA device 30 in the LAN 10, the metadata providing apparatus 20 generates a conversion table. When an acquisition request of content information metadata is received from the DLNA device 30 in the LAN 10, the metadata providing apparatus 20 generates no conversion table. Thus, the metadata providing apparatus 20 can reduce processing costs accompanying conversion table generation.

To convert the content metadata acquired from the content providing apparatus 50 into a DIDL-Lite format, the metadata providing apparatus 20 uses a content information metadata address as a content identifier (ID). Thus, the metadata providing apparatus 20 can immediately acquire content information metadata from the content providing apparatus 50 in response to an acquisition request of content information metadata from the DLNA device 30 in the LAN 10. As a result, the metadata providing apparatus 20 doesn't have to solve an address for acquiring content information metadata from a content identifier.

The metadata providing apparatus 20 stores a content list metadata acquisition address in the conversion table. Thus, the metadata providing apparatus 20 can immediately acquire content list metadata from the content providing apparatus 50 in response to a content list metadata acquisition request from the DLNA device 30 in the LAN 10. As a result, the metadata providing apparatus 20 doesn't have to solve an address for acquiring content list metadata from a content identifier.

The case where the hierarchical storage area managed by the content providing apparatus is a directory has been described as the example. However, for example, a folder corresponding to the directory may also be used as the storage area.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-134412 filed Jun. 3, 2009, which is hereby incorporated by reference herein in its entirety.

What is claimed is:

1. An attribute apparatus connected to a management apparatus that manages a directory for storing contents and a request apparatus that requests attributes of the contents, comprising:
a storage unit configured to store an identifier of the directory and identifiers of the contents;
an acquisition unit configured to acquire attribute data of the contents in response to a request; and
a providing unit configured to provide the acquired attribute data and the identifier of the directory corresponding to the identifiers of the contents whose attributes have been acquired, to the request apparatus.

2. The attribute apparatus according to claim 1, wherein the storage unit stores the identifiers of the contents acquired from the management apparatus by the acquisition unit.

3. The attribute apparatus according to claim 1, wherein when an identifier of a subdirectory included in the directory and an identifier of a second content stored in the subdirectory are acquired in response to a request, the storage unit stores the identifier of the subdirectory and the identifier of the second content, and the providing unit provides attribute data of the second content and the identifier of the subdirectory according to the identifier of the second content, to the request apparatus.

4. The attribute apparatus according to claim 1, wherein the storage unit stores an identifier of a subdirectory included in the directory, the acquisition unit acquires address information to acquire an identifier of a second content stored in the subdirectory, and the storage unit stores the acquired address information, in association with the identifier of the subdirectory.

5. The attribute apparatus according to claim 4, wherein the acquisition unit acquires the identifier of the second content by using the address information, and the storage unit stores the identifier of the second content and the identifier of the subdirectory.

6. The attribute apparatus according to claim 1, wherein the identifier of the directory is address information to acquire attribute data of the directory.

7. The attribute apparatus according to claim 6, wherein when an identifier of a content stored in a root directory is requested, the storage unit stores an address to acquire the identifier of the content stored in the root directory, and when attribute data of the content stored in the root directory is requested, the providing unit provides the attribute data and a specific value indicating the root directory in a procedure of acquiring the attribute data, to the request apparatus, and when attribute data of a content stored in a directory below the root directory is requested, the attribute data and address information to acquire the attribute data of the directory in which the content has been stored, to the request apparatus.

8. A method for providing attribute data to a request apparatus, which is implemented by an attribute apparatus connected to a management apparatus that manages a directory for storing contents and the request apparatus that requests attributes of contents, and configured to store an identifier of the directory and identifiers of the contents,
the method comprising:
acquiring attribute data of the contents in response to a request; and
providing the acquired attribute data and the identifier of the directory stored corresponding to the identifiers of the contents whose attributes have been acquired, to the request apparatus.

9. The method according to claim 8, wherein the identifiers of the contents are stored corresponding to the identifier of the directory in which the acquired contents have been stored.

10. The method according to claim 8, wherein when an identifier of a subdirectory included in the directory and an identifier of a second content stored in the subdirectory are acquired in response to a request, the identifier of the subdirectory and the identifier of the second content, and attribute data of the acquired second content and the identifier of the subdirectory stored according to the identifier of the second content are provided to the request apparatus.

11. The method according to claim 8, wherein address information to acquire an identifier of a second content stored in a subdirectory is acquired from the management apparatus, and the acquired address information and the identifier of the directory are stored with an identifier of the subdirectory.

12. The method according to claim 11, wherein the acquired identifier of the second content and the identifier of the subdirectory in which the second content has been stored are stored in association.

13. The method according to claim 8, wherein address information to acquire attribute data of the directory is read as the stored identifier of the directory.

14. The method according to claim 13, wherein when an identifier of a content stored in a root directory is requested, an address to acquire the identifier of the content stored in the root directory is stored, when attribute data of the content stored in the root directory is requested, the attribute data, and a specific value indicating the root directory in a procedure of acquiring the attribute data are provided to the request apparatus, and when attribute data of a content stored in a directory below the root directory is requested, the attribute data and address information to acquire the attribute data of the directory in which the content has been stored are provided to the request apparatus.

15. A storage medium storing a computer program for providing attribute data to a request apparatus, which is executed by a computer connected to a management apparatus that manages a directory for storing contents and the request apparatus that requests attributes of contents, and configured to store an identifier of the directory and identifiers of the contents, the program comprising:
acquiring attribute data of the contents in response to a request; and
providing the acquired attribute data and the identifier of the directory stored corresponding to the identifiers of the contents whose attribute data have been acquired to the request apparatus.

16. The storage medium according to claim 15, wherein when an identifier of a subdirectory included in the directory and an identifier of a second content stored in the subdirectory are further acquired in response to a request, the identifier of the subdirectory and the identifier of the second content are stored, and attribute data acquired further of the second content and the identifier of the subdirectory stored according to the identifier of the second content are provided to the request apparatus.

17. The storage medium according to claim 15, wherein address information to acquire an identifier of a second content stored in a subdirectory included in the directory is acquired from the management apparatus, and the acquired address information and the identifier of the directory are stored with an identifier of the subdirectory.

18. The storage medium according to claim 17, wherein the acquired identifier of the second content and the identifier of the subdirectory in which the second content has been stored are stored in association.

19. The storage medium according to claim 15, wherein address information to acquire attribute data of the directory is read as the stored identifier of the directory.

20. The storage medium according to claim 19, wherein when an identifier of a content stored in a root directory is requested, an address to acquire the identifier of the content stored in the root directory is stored, when attribute data of the content stored in the root directory is requested, the attribute data and a specific value indicating the root directory in a procedure of acquiring the attribute data are provided to the request apparatus, and when attribute data of a content stored in a directory below the root directory is requested, the attribute data and address information to acquire the attribute data of the directory in which the content has been stored are provided to the request apparatus.
